(19) United States
(12) Patent Application Publication
(10) Pub. No.: US 2016/0257267 A1
(43) Pub. Date: Sep. 8, 2016

(54) WIRE PROTECTING MEMBER

(71) Applicant: Sumitomo Wiring Systems, Ltd., Yokkaichi (JP)

(72) Inventor: Hirokazu Nakai, Yokkaichi (JP)

(21) Appl. No.: 15/019,986

(22) Filed: Feb. 10, 2016

(30) Foreign Application Priority Data
Mar. 2, 2015 (JP) 2015-040179

(51) Int. Cl. B60R 16/02; H01B 7/00; H01B 7/20; H01B 7/18; H01B 3/28

(52) U.S. Cl. CPC B60R 16/0215; H01B 7/184; B60R 16/0222; H01B 3/28; H01B 7/20; H01B 7/0045

(57) ABSTRACT

A wire protecting member (10) accommodates and protects wires (11, 12) to be routed in a vehicle inside. The wire protecting member (10) includes an corrugated tube (40) with an inner tube portion (41) open on an end and having the wires (11, 12) inserted therein, a grommet (60) including an outer tube portion (61) having an inner diameter larger than an inner diameter in the case of external fitting to the inner tube portion (41) without any clearance and having the wires (11, 12) inserted therein. An auxiliary grommet (90) is interposed between the inner tube portion (41) and the outer tube portion (61) to couple the corrugated tube (40) and the grommet (60).

### BACKGROUND

1. Field of the Invention

This disclosure relates to a wire protecting member.

2. Description of the Related Art

Japanese Unexamined Patent Publication No. 2012-226948 discloses a pipe harness to be routed along a front-back direction of a vehicle. This known pipe harness has a shield pipe, a corrugated tube through which a plurality of wires are inserted, and a rubber boot connecting the shield pipe and the corrugated tube in a sealed state. The rubber boot functions as a grommet and includes a pipe-side fitting to be fit externally to an end of the shield pipe and a tube-side fitting to be fit externally to an end part of the corrugated tube. Sealing is provided between the shield pipe and the rubber boot by close contact between the inner peripheral surface of the pipe-side fitting and the outer peripheral surface of the shield pipe. On the other hand, inner peripheral projections are provided circumferentially on the inner peripheral surface of the tube-side fitting and fit into outer peripheral recesses of the corrugated tube.

The size of the wires is determined by the current applied to the wires. Thus, a diameter of the shield pipe and a diameter of the pipe-side fitting of the rubber boot through which the wires are inserted also become smaller if the size of the wires becomes smaller. Further, a diameter of the tube-side fitting of the rubber boot has to be reduced if a diameter of the corrugated tube becomes smaller. Thus, it has been necessary to remake the rubber boot and to manufacture a new mold for molding this rubber boot.

### SUMMARY

The invention relates to wire protecting member for accommodating and protecting a wire to be routed in a vehicle. The wire protecting member includes an exterior material, a grommet and an auxiliary grommet. The exterior material has an inner tube portion open on an end and having the wire inserted therein. The grommet has an outer tube portion with an inner diameter larger than an inner diameter in the case of external fitting to the inner tube portion without any clearance and having the wire inserted therein. The auxiliary grommet is interposed between the inner tube portion and the outer tube portion to couple the exterior material and the grommet.

According to this configuration, even if the sizes of the wire and the exterior material becomes smaller, the size of the grommet need not be reduced and the inner tube portion of the exterior material and the outer tube portion of the grommet can be coupled by the auxiliary grommet. Thus, it is not necessary to make a new grommet and a new mold for the grommet.

As just described, existing components can be used and specification changes of the existing components can be dealt with quickly merely by providing a new auxiliary grommet. Further, the auxiliary grommet has only to be mounted in a part connecting the grommet and the exterior material. Thus, the size of the auxiliary grommet can be suppressed to a minimum size.

The inner tube portion of the corrugated tube and the outer tube portion of the grommet can be coupled by an auxiliary grommet only when the size of the exterior material becomes smaller or when the size of the grommet becomes larger. Thus, the exterior material need not be remade according to a size change of the grommet.

The auxiliary grommet may have a tubular shape and may be mounted between an outer peripheral surface of the inner tube portion and an inner peripheral surface of the outer tube portion. Accordingly, the auxiliary grommet is incorporated as a part of a section where the inner tube portion and the outer tube portion are fit and connected. Therefore the overall shape of the wire protecting member need not be changed.

The auxiliary grommet may be formed of rubber and stops water between the inner tube portion and the outer tube portion. According to this configuration, the auxiliary grommet can be substituted for a seal.

The exterior material may be a bellows-like corrugated tube with alternating crests and troughs, and the auxiliary grommet may include a projection to be fit into a trough. Accordingly, the auxiliary grommet can be positioned relative to the exterior material in an axial direction by fitting the projection into the trough to prevent axial displacement of the auxiliary grommet.

The grommet and the auxiliary grommet may be fixed to the corrugated tube by a fastening band. The fastening band may be mounted at a position for pressing the crest of the corrugated tube. This configuration reliably stops water between the grommet and the corrugated tube.

The exterior material may be a shield pipe made of metal. According to this configuration, the auxiliary grommet also can be applied to the part coupling the shield pipe and the grommet.

The wire protecting member disclosed by this specification uses an auxiliary grommet so that existing components can be used.

### BRIEF DESCRIPTION OF THE DRAWINGS

FIG. 1 is a plan view showing a wire protecting member in an embodiment.

FIG. 2 is a section showing a state where an auxiliary grommet is mounted between a grommet and a corrugated tube.

FIG. 3 is a section showing a state where an auxiliary grommet is mounted between a forked grommet and a shield pipe.

### DETAILED DESCRIPTION

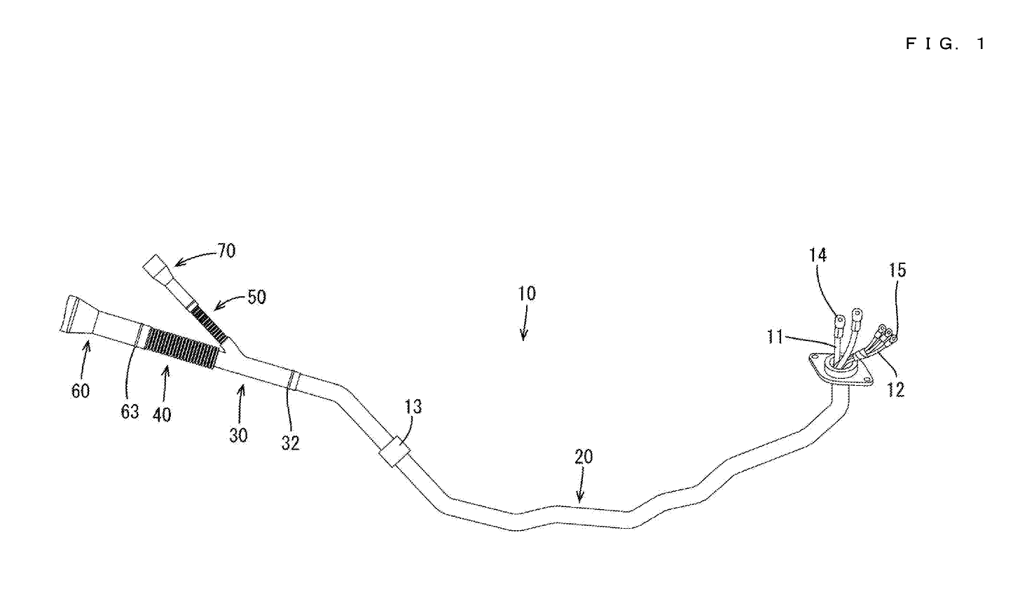

As shown in FIG. 1, a wire protecting member 10 of this embodiment includes a shield pipe 20 for accommodating and protecting thick and thin wires 11, 12, a clamp 13 for fixing the shield pipe 20 to a body of a vehicle, a forked grommet 30 connected to an end part of the shield pipe 20, two types of large and small corrugated tubes 40, 50 connected to end parts of the forked grommet 30 and two types of large and small grommets 60, 70 connected to end parts of the corrugated tubes 40, 50.

Large and small terminals 14, 15 are connected respectively to end parts of the thick and thin wires 11, 12 on a vehicle rear side (right side shown). The thick wires 11 and the large terminals 14 mounted on these wires constitute a power circuit for driving and the like. On the other hand, the thin wires 12 and the small terminals 15 mounted on these wires constitute a signal circuit for control and the like. Each wire 11, 12 has a core configured by twisting electrically conductive metal strands and is surrounded by an insulation coating made of synthetic resin.

The shield pipe 20 is a hollow cylindrical member made of electrically conductive metal (e.g. aluminum alloy) and functions to shield and protect the wires 11, 12. The shield pipe 20 is bent at a plurality of positions after the wires 11, 12 are inserted into a straight pipe. Thus, a length of the shield pipe 20 is shorter than the entire lengths of the wires 11, 12.

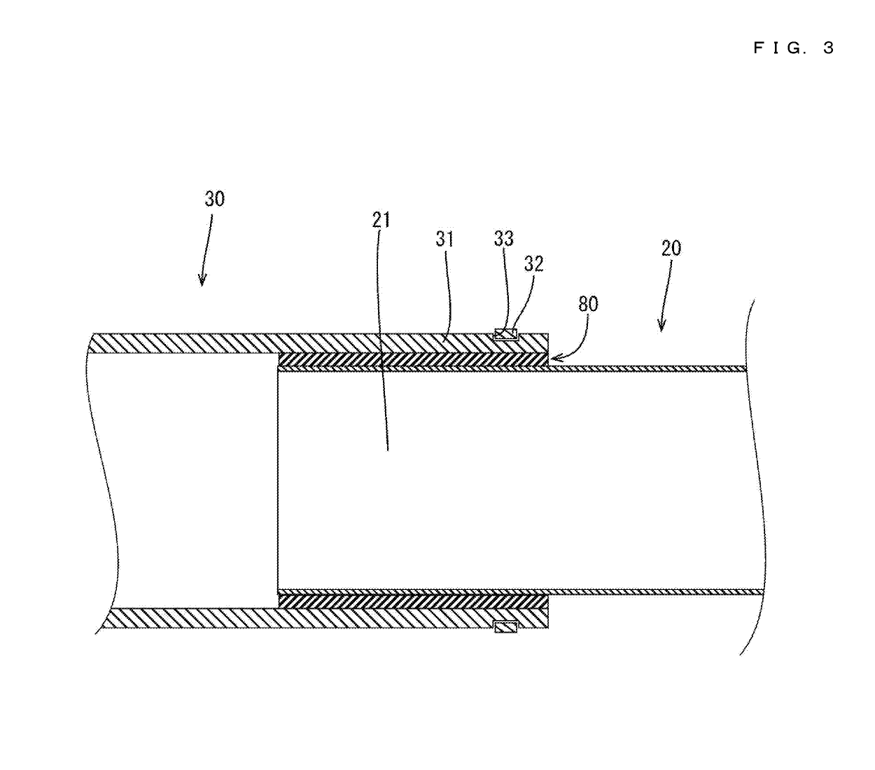

The forked grommet 30 is formed of rubber and includes an outer tube portion 31 to be fit externally to an inner tube portion 21 open on the end part of the shield pipe 20, as shown in FIG. 3. This outer tube portion 31 is open on the end part of the forked grommet 30. The inner tube portion 21 and the outer tube portion 31 are fit to each other and a first auxiliary grommet 80 is interposed between the outer peripheral surface of the inner tube portion 21 and the inner peripheral surface of the outer tube portion 31. The first auxiliary grommet 80 connects the outer peripheral surface of the inner tube portion 2 to the inner peripheral surface of the outer tube portion 31 without any clearance. Note that interposition means located between two members and being mounted to the two members. Thus, the first auxiliary grommet 80 is between the outer peripheral surface of the inner tube portion 21 and the inner peripheral surface of the outer tube portion 31 and is mounted to both the outer peripheral surface of the inner tube portion 21 and the inner peripheral surface of the outer tube portion 31.

A mounting recess 33 is provided circumferentially on the outer peripheral surface of the outer tube portion 31. The outer tube portion 31 and the first auxiliary grommet 80 are pressed against the inner tube portion 21 by fastening a fastening band 32 in the mounting recess 33. Thus, the outer tube portion 31 and the auxiliary grommet 80 are fixed to the inner tube portion 21 so that the auxiliary grommet 80 provides sealing between the forked grommet 30 and the shield pipe 20.

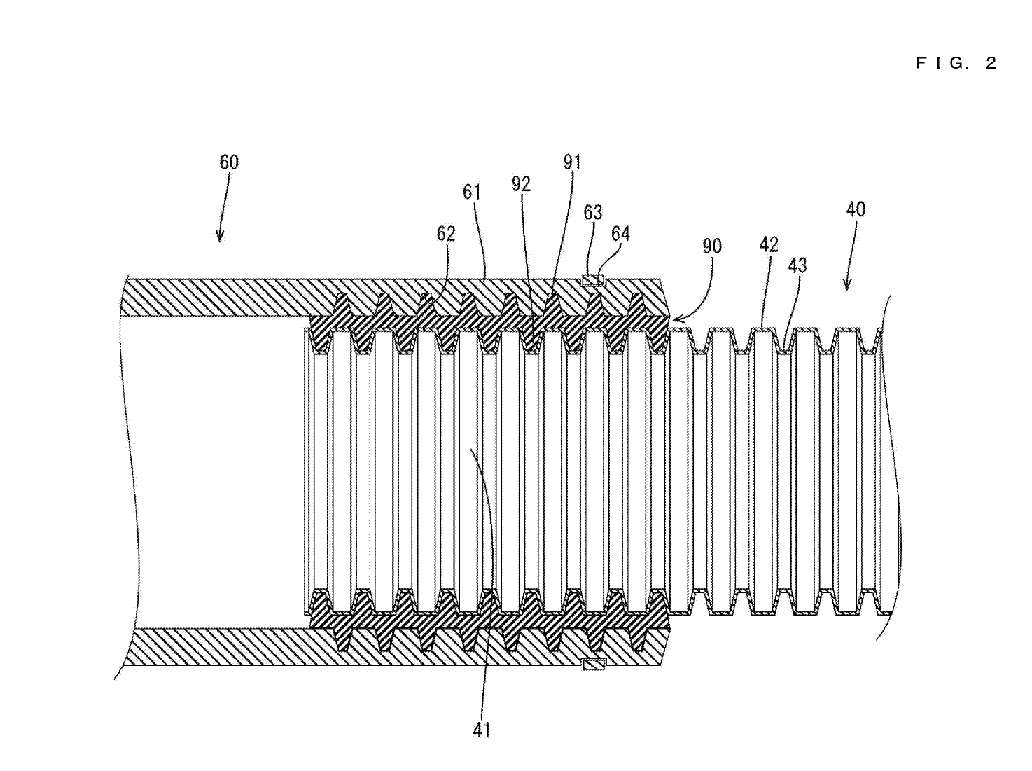

An inner tube portion 41 is provided open on an end part of the corrugated tube 40 and an outer tube portion 61 is provided open on an end part of the grommet 60, as shown in FIG. 2. A second auxiliary grommet 90 is interposed between the outer peripheral surface of the inner tube portion 41 and the inner peripheral surface of the outer tube portion 61. The inner tube portion 41 is arranged radially inward of the outer tube portion 61. The second auxiliary grommet 90 connects the outer peripheral surface of the inner tube portion 41 to the inner peripheral surface of the outer tube portion 61 without any clearance.

The corrugated tube 40 is made of synthetic resin and defines a known bellows structure with alternating crests 42 and troughs 43.

The grommet 60 is formed of a rubber and has inner peripheral recesses 62 provided on the inner peripheral surface of the outer tube portion 61 of the grommet 60. The inner peripheral recesses 62 are provided circumferentially along crests so that the crests are fit therein if a corrugated tube has an original size fittable to the grommet 60. However, the corrugated tube 40 is smaller than the original corrugated tube in this embodiment. Thus, the inner peripheral recesses 62 are not fit to the crests 42. Further, a plurality of inner peripheral recesses 62 are provided in an arrangement direction of the crests 42 within a range of the outer tube portion 61. An interval between the inner peripheral recesses 62 is equal to that between the crests 42.

The second auxiliary grommet 90 is formed of rubber and has outer peripheral projections 91 that fit in the inner peripheral recesses 62 of the grommet 60. On the other hand, inner peripheral projections 92 are provided circumferentially on the inner peripheral surface of the second auxiliary grommet 90 to fit into the troughs 43 of the corrugated tube 40. The outer peripheral projections 91 and the inner peripheral projections 92 are arranged at the same interval and are arranged alternately in an axial direction.

, the second auxiliary grommet 90 is positioned relative to the corrugated tube 40 by fitting the inner peripheral projections 92 into the troughs 43 to prevent axial displacement. Further, the second auxiliary grommet 90 is positioned relative to the grommet 60 by fitting the outer peripheral projections 91 into the inner peripheral recesses 62, to prevent axial displacement.

A mounting recess 64 is provided circumferentially on the outer peripheral surface of the outer tube portion 61 of the grommet 60 and a fastening band 63 can be fit therein. The mounting recess 64 is located at an outer peripheral side of one of the inner peripheral recesses 62. Thus, a crest 42 of the corrugated tube 40 is located at an inner peripheral side of the mounting recess 64. Accordingly, when the fastening band 63 is fastened in the mounting recess 64, the inner peripheral recess 62 presses the outer peripheral projection 91 of the second auxiliary grommet 90 and the inner peripheral surface of the second auxiliary grommet 90 presses the crest 42 of the corrugated tube 40. In this way, the auxiliary grommet 90 provides sealing between the grommet 60 and the corrugated tube 40.

The outer peripheral projections 91 of the second auxiliary grommet 90 are covered by the grommet 60. Thus, water is unlikely to enter between the second auxiliary grommet 90 and the grommet 60 even if water directly hits the end part of the grommet 60 when the vehicle is washed with high-pressure water.

As described above, the size of the grommet 60 needs not to be reduced and the inner tube portion 41 of the corrugated tube 40 and the outer tube portion 61 of the grommet 60 can be coupled by the auxiliary grommet 90 even if the sizes of the wires become smaller and the size of the corrugated tube 40 becomes smaller. Thus, it is not necessary to remake the grommet and newly manufacture a mold for molding the grommet.

As just described, existing components can be used and specification changes of the existing components can be dealt with quickly, merely by preparing the new second auxiliary grommet 90. Further, the second auxiliary grommet 90 only has to be mounted in a part connecting the grommet 60 and the corrugated tube 40, and can be very small.

The inner tube portion 41 of the corrugated tube 40 and the outer tube portion of the grommet can be coupled by using an auxiliary grommet when the size of the corrugated tube 40 becomes smaller, as described above, and also when the size of the grommet 60 becomes larger. Thus, the corrugated tube 40 need not be remade according to a size change of the grommet 60.

The auxiliary grommet 90 may be tubular and may be between the outer peripheral surface of the inner tube portion 41 and the inner peripheral surface of the outer tube portion 61. According to this configuration, the auxiliary grommet 90 is incorporated as a part of a section where the inner tube portion 41 and the outer tube portion 61 are connected. Therefore, the overall shape of the wire protecting member 10 need not be changed.

The second auxiliary grommet 90 may be formed of rubber and stops water between the inner tube portion 41 and the outer tube portion 61. Thus, the auxiliary grommet 90 can be substituted for a seal.

An exterior material may be the bellows-like corrugated tube 40 in which the crests 42 and the troughs 43 are arranged alternately and the second auxiliary grommet 90 may include the inner peripheral projections 92 to be fit into the trough portions 43. Thus, the second auxiliary grommet 90 can be positioned relative to the corrugated tube 40 in the axial direction by fitting the inner peripheral projections 92 into the troughs 43. Further, a displacement of the second auxiliary grommet 90 in the axial direction can be avoided.

The grommet 60 and the second auxiliary grommet 90 may be fixed to the corrugated tube 40 by the fastening band 63. Accordingly, the grommet 60 and the auxiliary grommet 90 can be fixed firmly to the corrugated tube 40 by using the fastening band 63.

The fastening band 63 may be mounted at a position for pressing the crest 42 of the corrugated tube 40. According to this configuration, the second auxiliary grommet 90 is pressed against the crest 42 of the corrugated tube 40 by fastening the fastening band 63, wherefore water can be reliably stopped between the grommet 60 and the corrugated tube 40.

The exterior material may be the shield pipe 20 made of metal. Thus, the first auxiliary grommet 80 can be applied also to the part coupling the shield pipe 20 and the forked grommet 30.

The technology disclosed by this specification is not limited to the above described and illustrated embodiment. For example, the following various modes are also included.

Although the part to be mounted to the outer peripheral surface of the inner tube portion 41 and the part to be mounted to the inner peripheral surface of the outer tube portion 61 are integral in the second auxiliary grommet 90. However, a part to be mounted to the outer peripheral surface of the inner tube portion 41 and a part to be mounted to the inner peripheral surface of the outer tube portion 61 may be at different axial positions in an auxiliary grommet.

Although the auxiliary grommets 80, 90 made of rubber are illustrated in the above embodiment, auxiliary grommets made of resin may be used in a wire protecting member that need not have waterproof performance.

The auxiliary grommet 90 has the inner peripheral projections 92 to fit into the troughs 43 of the corrugated tube 40 in the above embodiment. However, the inner peripheral projections 92 may not be necessarily provided.

The grommet 60 is fastened with the fastening band 63 in the above embodiment. However, the inner peripheral surface of the outer tube portion 61 and the outer peripheral surface of the auxiliary grommet may be held in close contact and the inner peripheral surface of the auxiliary grommet and the outer peripheral surface of the inner tube portion 41 of the corrugated tube 40 may be held in close contact by forming the auxiliary grommet thicker than that of the embodiment.

The fastening band 63 is mounted at a position for pressing one crest 42 in the above embodiment. However, a wide fastening band may press two or more crests 42.

Although the hollow cylindrical shield pipe 20 and the hollow cylindrical corrugated tubes 40, 50 are illustrated as the exterior materials in the above embodiment, rectangular tubular resin pipes may be used as the exterior materials.

### LIST OF REFERENCE SIGNS

10 . . . wire protecting member
11, 12 . . . wire
20 . . . shield pipe
21 . . . inner tube portion
30 . . . forked grommet
31 . . . outer tube portion
32 . . . fastening band
40 . . . corrugated tube
41 . . . inner tube portion
42 . . . crest
43 . . . trough
50 . . . corrugated tube
60 . . . grommet
61 . . . outer tube portion
63 . . . fastening band
70 . . . grommet
80 . . . first auxiliary grommet for pipe
90 . . . second auxiliary grommet for tube
92 . . . inner peripheral projection

What is claimed is:

1. A wire protecting member (10) for accommodating and protecting a wire (11, 12) to be routed in a vehicle, comprising:
an exterior material (20, 40) including an inner tube portion (21, 41) open on an end part and having the wire (11, 12) inserted therein, the inner tube portion (21, 41) having an outer diameter;
a grommet (30, 60) including an outer tube portion (31, 61) having an inner diameter larger than an outer diameter of the inner tube portion (21, 41) and having the wire (11, 12) inserted therein; and
an auxiliary grommet (80, 90) interposed between the inner tube portion (21, 41) and the outer tube portion (31, 61) to couple the exterior material (20 40) and the grommet (30, 60).

2. The wire protecting member of claim 1, wherein the auxiliary grommet (80, 90) has a tubular shape and is mounted between an outer peripheral surface of the inner tube portion (21 41) and an inner peripheral surface of the outer tube portion (31, 61).

3. The wire protecting member of claim 2, wherein the auxiliary grommet (80, 90) is formed of a rubber and stops water between the inner tube portion (21) and the outer tube portion (31, 61).

4. The wire protecting member of claim 3, wherein the exterior material (20, 40) is a bellows-like corrugated tube (40) with crests (42) and troughs (43) alternately arranged and the auxiliary grommet (90) includes projections (92) to be fit into the troughs (43).

5. The wire protecting member of claim 4, wherein the grommet (60) and the auxiliary grommet (90) are fixed to the corrugated tube (40) by a fastening band (63).

6. The wire protecting member of claim 5, wherein the fastening band (63) is mounted at a position for pressing one of the crests (42) of the corrugated tube (40).

7. The wire protecting member of claim 3, wherein the exterior material (20) is a shield pipe (21) made of metal.
